(19) United States
(12) Patent Application Publication
(10) Pub. No.: US 2004/0155861 A1
(43) Pub. Date: Aug. 12, 2004

(54) Portable display monitor

(76) Inventor: Robert P. Jackson III, Long Lake, MN (US)

Correspondence Address: GRAY, PLANT, MOOTY, MOOTY & BENNETT, P.A., P.O. BOX 2906, MINNEAPOLIS, MN, 55402-0906, US

(21) Appl. No.: 10/478,832

(22) PCT Filed: May 30, 2002
(86) PCT No.: PCT/US02/17293

(51) Int. Cl. G09G 5/00

(52) U.S. Cl. 345/156

(57) ABSTRACT

A portable display monitor having a flat panel display screen and an integral base/cover pivotally attached to each other. The base/cover covers and protects the display screen during non-use and especially during transit, and serves as a base for deployment of the flat panel display screen at appropriate viewing angles. In a preferred embodiment, the base/cover rotates around the back of the screen between 180 and 360 degrees from the closed position. The monitor is adapted for use with other devices such as portable computers, desktop computers and the like, so that the monitor may serve as a duplicate or auxiliary display viewable from a variety of locations, notably locations other than those which any display normally employed by the devices may be viewed. In other embodiments, the monitor supports other electronic functions such as auxiliary power.

### CROSS REFERENCE TO RELATED APPLICATION

This application claims the benefit of provisional application No. 60/294,738 filed May 30, 2001.

### TECHNICAL FIELD

This invention relates to visual displays generally, and, more particularly, to portable visual display monitors.

### BACKGROUND

Visual displays, including cathode ray tube (CRT) displays, flat panel displays (e.g., flat panel liquid crystal displays, or LCDs, and flat panel plasma displays), are popular output devices for conveying visual information generated by computer systems, as well as computer-driven devices such as medical monitoring devices, aeronautical displays, and many military applications. They also are used to display TV signals or video playback from devices such as videocassette recorders, DVD players, video cameras, video games, and other video or digital sources.

Many flat panel visual displays are used in portable devices, because the decreased weight and size of a flat panel display greatly increases versatility over a CRT display. Thus, flat panel displays are commonly incorporated into portable computers such as laptop computers. Flat panel displays are also found in stand-alone monitors used with non-portable desktop computers and workstations, as well as displays of digital and analog video. Flat panel displays are also found in stand-alone monitors used in conjunction with portable computers (just as CRT monitors have been used for some time), because they offer the user either a single larger display, or multiple displays that may display different sets of information.

A portable computer is a popular configuration enabling increased mobility for a user. Typically, the motherboard, display and keyboard are integrated into a common case in a portable configuration. The notebook computer typically has a display housing and a keyboard housing permanently attached to each other by a hinge system of some kind. A flat panel display is mounted within the display housing. A keyboard, motherboard, data storage unit(s), expansion slot, and I/O port are mounted in the keyboard housing.

Portable computers are often used in meetings to provide visual and audio information often referred to as multimedia. Typically, during large meetings with many attendees or lectures, video or data projectors are employed to present the information on to a screen for presentation to the audience with the audio portion of the presentation emanating from speakers housed within the projector or through an independent public address system.

### SUMMARY OF THE INVENTION

The invention involves methods of providing an image on a portable display system connected to a display driver apparatus. The portable display system has open and closed positions. One major component of the system is a generally planar display portion having a front face and a back face. Another component is a graphic display panel arranged to be viewable on the front face of the display portion. Another major component is a generally planar base/cover portion having a base surface and a cover surface. This component has sufficient size to substantially cover the graphic display panel when the system is in the closed position, during which the display portion is parallel to the base/cover portion. The two portions are connected together to enable relative motion of the display portion to the base/cover portion between the open and closed positions. One suitable form of connection is a compound hinge (or equivalent) attached to an outer periphery (e.g., an outer edge or other region adjacent the edge) of the base/cover portion and an outer periphery of the display portion. To hold the two portions in appropriate positions with respect to each other, the system includes any suitable feature to ensure that the display system may be exposed for viewing and held in the open position. When so held in place, the angle between the back face of the display portion and the base/cover portion is greater than zero degrees and less than one hundred eighty degrees.

### BRIEF DESCRIPTION OF THE DRAWINGS

The accompanying drawings show a particular embodiment of the invention as an example, and are not intended to limit the scope of the invention.

FIG. 1 is schematic view of one embodiment of the invention, specifically a portable flat screen display monitor in the open position.

FIG. 2 is a schematic view of the combination of a laptop computer and the portable flat panel display monitor of FIG. 1, connected to each other via cable.

FIG. 3 is a schematic view of the combination of a personal digital assistant (PDA) and the portable flat panel display monitor of FIG. 1, connected to each other via cable.

FIG. 4A is a side view of the embodiment of FIG. 1 in the closed position.

FIG. 4B is a side view of the embodiment of FIG. 4A in the open position.

FIG. 4C displays the range of relative position possible in the embodiment of FIGS. 4A and 4B.

FIG. 5 is a schematic view of the combination of a handheld computer or portable digital assistant (PDA) and another embodiment of a portable flat panel display monitor, in which the PDA is directly connected (“docked”) to the portable flat panel display monitor.

FIG. 6A is a side view of the embodiment of FIG. 5 in which a universal connector is used and the PDA is about to be connected to the portable flat panel display monitor.

FIG. 6B is a side view similar to FIG. 6A, but the PDA is fully docked to the portable flat panel display monitor.

FIG. 6C is an side view of an alternative embodiment of FIG. 5, in which a universal connector is used and the PDA is about to be docked to the portable flat panel display monitor, but in which a different type of docking feature is employed.

FIG. 6D is a side view similar to FIG. 6C, but the PDA is fully docked to the portable flat panel display monitor.

FIG. 7 is a schematic view of a component of an alternative embodiment of the invention.

FIG. 8 is a schematic view of one embodiment of the invention.

FIG. 9 is a side view of the embodiment of FIG. 8, illustrating the range of tilt available in preferred embodiments of the invention.

FIG. 9A illustrates the embodiment in the open position.

FIG. 9B illustrates the embodiment in a partially open position.

FIG. 9C illustrates the embodiment in a nearly closed position.

FIG. 9D illustrates the embodiment in the closed position.

FIG. 10 is a schematic partial view of an alternative embodiment of the invention. FIG. 10A shows the embodiment in one position, while FIGS. 10B and 10C show the same embodiment in a partially open position but from different angles.

### DETAILED DESCRIPTION

Because the invention may be considered and defined as a system, or as a method, and in a variety of embodiments, this disclosure should be understood to describe the invention in such terms even if only one particular embodiment is described in detail at any given point. Thus, for convenience only, the following description tends to focus on a system embodiment to disclose the preferred embodiment of the invention, but this is by way of example only and not a limitation on the scope of the invention.

Similarly, this disclosure should be understood to include either analog or digital data or video or other signals, in accordance with principles known in the art. Thus, the terms “signal,” “data” and the like may be used interchangeably, and should be understood to apply to either analog or digital representations of information.

One of the display shortcomings of a notebook computer is evident when it is used to make a presentation to small groups of one or more people. The options are to present the audio and video or multimedia information directly from the portable computer's built-in display, or to plug into the laptop an additional monitor (if one is even present). However, there are many situations in which an additional monitor is not available. If an additional monitor is available, it may be an integral part of an existing computer desktop installation and thus require disconnection from its normal operation, typically involving one or more cable connectors between the personal computer and the monitor. This can prove to be inconvenient when making a presentation.

A variety of “multiple-monitor” computer configurations are known, but none have achieved commercial success. Examples include U.S. Pat. No. 5,128,662 (composite flat panel monitor comprising hingedly connected multiple flat panel sections); U.S. Pat. No. 5,590,021 (pivotably mounted secondary flat panel display); U.S. Pat. No. 5,796,577 (two oppositely facing flat panel monitors incorporated into laptop cover); U.S. Pat. No. 6,094,341 (pivotably folded half-sized dual flat panel monitors that may face in opposed directions); and U.S. Pat. No. 6,295,038 (secondary flat panel monitor slides upward, then pivots downward to face oppositely from the primary monitor). The entirety of each of these patents is incorporated by reference; the techniques they disclose for movably connecting flat panel monitors to other portions of a computer system are within the scope of the invention depending on the embodiment chosen.

When another display monitor is not available, the presentation of audio and video or multimedia information must therefore be made from the portable computer itself This requires the presenter of the information to share the computer display with the small audience to whom the multimedia information is being presented. During the presentation it is often required that the presenter have the ability of interfacing with the portable computer through the computer keyboard to affect the presentation. It is difficult for the presenter to be able to view the multimedia information while optimizing the viewing angle for presentation to the intended audience.

Various computer systems are known which allow for removable and detached use of various components, including those in which the LCD display portion of the portable computer may be disconnected from its host computer, or be oriented in a different viewing angle from the viewing angles available when the display and portable computer are embodied together in their normal “notebook” configuration. Although such a system enables the viewing angle of the display to be adjusted when the display is detached from the computer system, there are several problems with such a system.

One of the problems with current display technology in general is its lack of portability. One of the benefits of the portable computer is that the computer is readily transportable. With the exception of personal digital assistants (PDAs) or other handheld computers, in order to use most portable computers one need only unlatch the clamshell display housing, rotate the display housing away from the keyboard housing into an open position, and turn on the computer. (When closed against the keyboard housing, the display housing protects the display itself from damage.

There are many other examples in which a portable display is desirable, including audiovisual entertainment away from a power source while camping or traveling; medical applications when in transit; and monitoring situations in which a standalone, portable, lightweight, monitor is required.

As illustrated throughout the Figures, the invention involves methods and systems for displaying an image on a portable display system that is connected to a display driver apparatus. It is possible, but not required, that the display driver apparatus be physically incorporated into one of the base/cover portion and display portion. In the more typical situation, the display driver apparatus is a separate computer such as a laptop computer or other handheld computer personal computer, such as those known as “personal digital assistants” or PDAs.

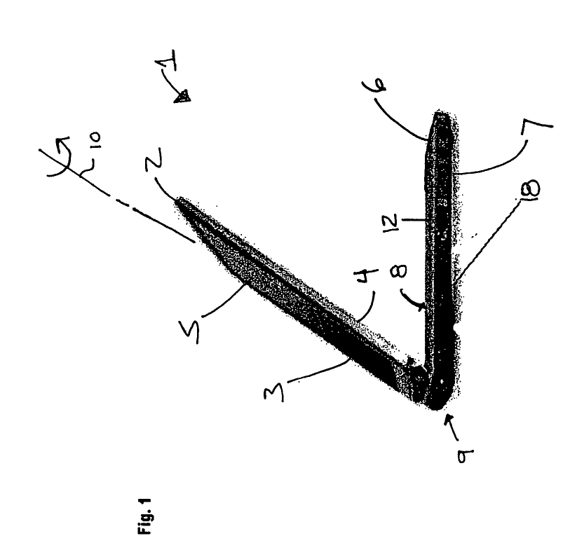

Referring to FIG. 1, one major component of the system 1 is a generally planar display portion 2 having a front face 3 and a back face 4. Another component is a graphic display panel 5 arranged to be viewable on the front face of the display portion. Another major component is a generally planar base/cover portion 6 having a base surface 7 and a cover surface 8. This component has sufficient size to substantially cover the graphic display panel when the system is in a closed position, during which the display portion is parallel to the base/cover portion.

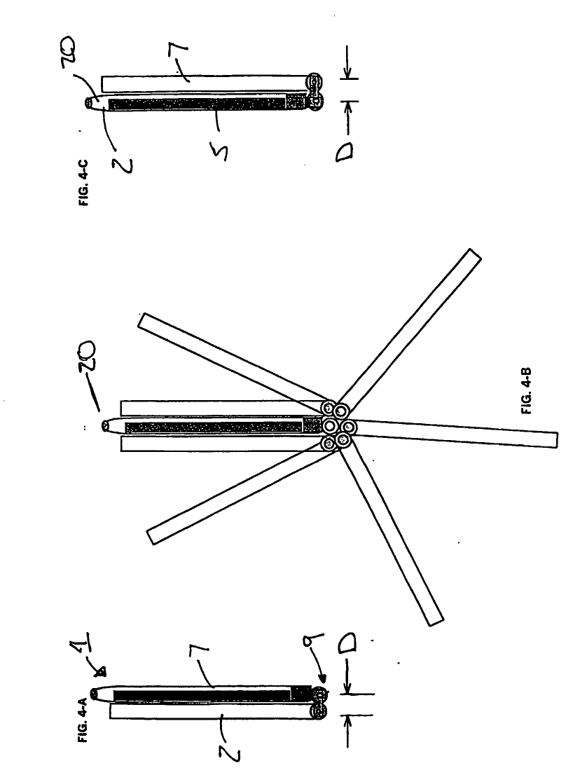

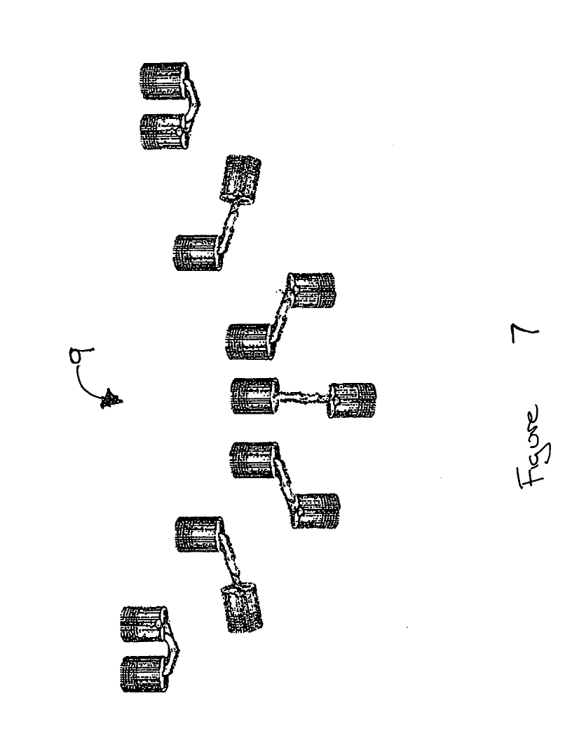

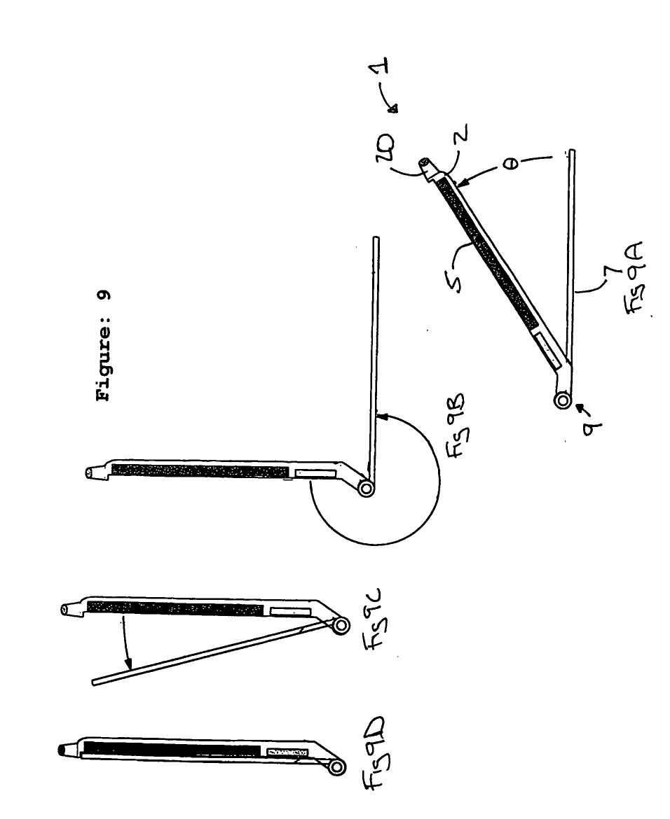

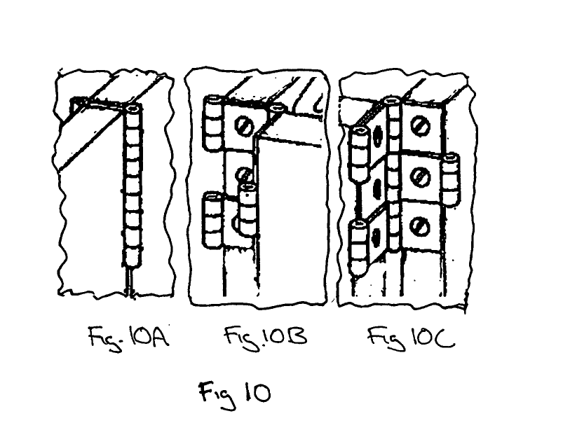

Referring also to FIGS. 4 and 9, the two portions are connected together in any suitable manner provided the required range of motion is provided, i.e, relative motion of the display portion to the base/cover portion between the open and closed positions. For example, a suitable form of compound hinge 9 (or equivalent) may be connected to an outer periphery (e.g., an outer edge or other region adjacent the edge) of the base/cover portion and an outer periphery of the display portion. Equivalent types of compound hinge include butt hinges, articulated hinges, and double action hinges. For example, FIGS. 10A, 10B, and 10C show the range of motion possible with a double action hinge suitable for some embodiments of the invention, and FIG. 7 shows the range of motion possible with an articulated hinge suitable for other embodiments of the invention. It will be understood that the type of hinge selected will dictate whether a pin is required. Similarly, the connection between the base/cover and display portions may comprise two linked features in a planetary gear relationship to each other.

To hold the two portions in appropriate positions with respect to each other, the system includes any suitable feature to ensure that the display system may be exposed for viewing and held in the open position. When so held in place, the angle θ between the back face of the display portion and the base/cover portion is greater than zero degrees and less than one hundred eighty degrees; in some preferred embodiments, this angle is in the range of approximately seventy degrees to approximately one hundred ten degrees.

The base surface of the base/cover portion may be immediately adjacent the display panel when the system is in the closed position, or the cover surface of the base/cover portion may be immediately adjacent the display panel when the system is in the closed position. In the former case, the two portions open in a conventional “clamshell” or “book” manner as do commercially available laptop computers. In the latter case, the display portion may undergo a 180 degree twist about its rotational axis 10 (FIG. 1) to achieve the fully open position. An example of this configuration, although in the laptop-like unitary configuration known under the trade name of “Tablet PC”, was disclosed at Fall COMDEX in 2001, prior to the filing date of this International Application by Acer Inc. (Taipei, Taiwan), under the model designation TravelMate 100 Tablet PC (but it is believed that no disclosure of this product occurred prior to the priority application date).

In a preferred embodiment, a compound hinge comprises a first section fixed to the base/cover portion and a second section fixed to the display portion. The first and second sections of the hinge have respective axes of rotation, and by offsetting those axes from each other by a distance D (FIG. 4) the desired rotation of the cover/base may rotate behind the back face of the display portion is achieved. Depending on the size of the hinge sections, it may be advisable for the compound hinge to further comprise a third section joining the first hinge section to the second hinge section but extending between the two and therefore providing the offset of the axes of rotation.

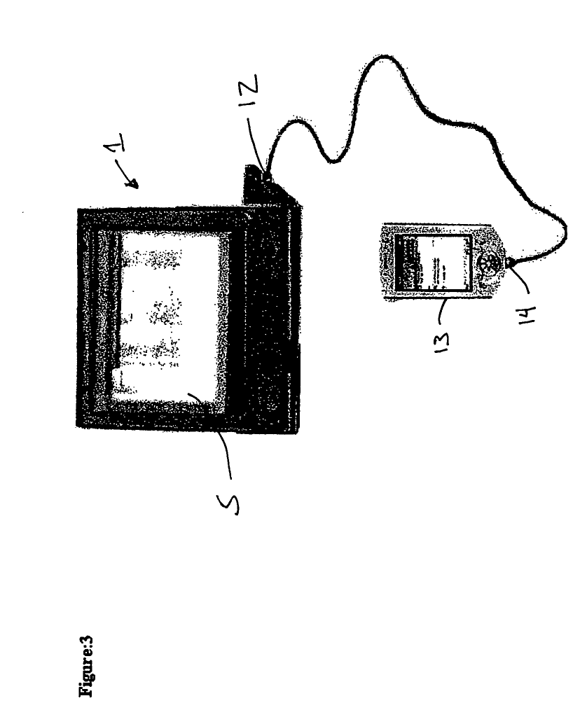

Examples of potentially suitable hinges are disclosed in U.S. Pat. No. 5,283,862 (notably FIG. 15); U.S. Pat. No. 5,555,157 (notably FIGS. 3, 4, and 5); U.S. Pat. Nos. 5,666,694; 5,737,183; The entireties of all these patents are incorporated by reference; the techniques they disclose for incorporating hinges into computer systems are within the scope of the invention depending on the embodiment chosen. It may be necessary to provide recessed features in the display portion to accommodate a portion of the hinge during rotation.

Regardless of the manner in which they are physically connected to provide the desired range of motion, any conventional electrical connection between the base/cover portion and the display portion is suitable, such as the “open cable” approach shown in U.S. Pat. No. 5,283,862 noted above. Alternatively, the connection may comprise at least one passage for the electrical connection, such as the example shown in U.S. Pat. No. 5,390,075, the entirety of which is incorporated by reference.

The display panel 5 may exploit any conventional display technology, including (without limitation) liquid crystal display (LCD), plasma display, organic light emitting diode (OLED), and touch screen display technologies.

Typically the connection between the base/cover portion and display portion provides sufficient friction to temporarily keep the base/cover portion and the display portion in the closed position. If necessary or desirable, the system may further comprise at least one latch to temporarily keep the base/cover portion and the display portion in the closed position. Similarly, it is possible but not required to have at least one handle 20 attached to the system either the base/cover portion, or the display portion, or both.

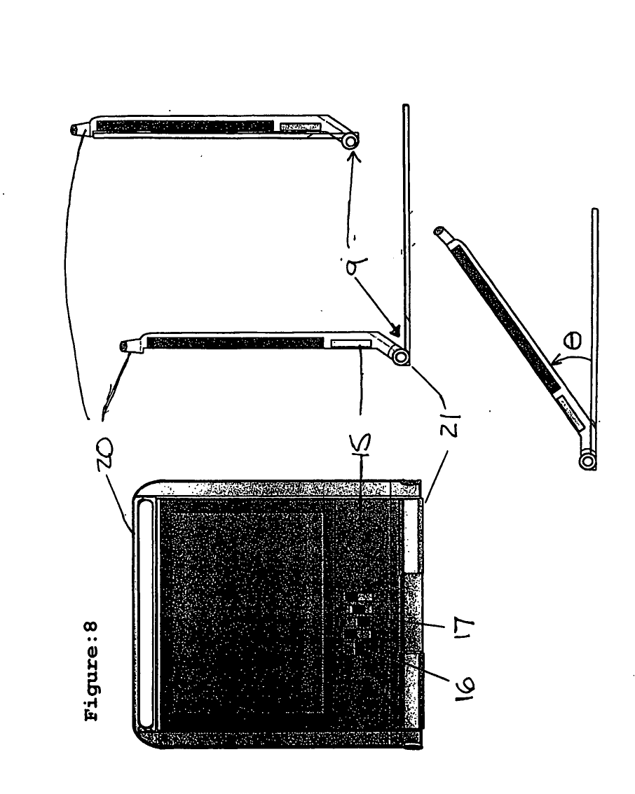

Also, the connection may provide sufficient friction to temporarily keep the base/cover portion and the display portion in the open position, and the ability to adjust the exact angle between the two is important to the need to position the graphic display panel at an appropriate viewing angle. Provided that sufficient adjustability is provided, the system may further comprise a feature to lock the display portion into the open position. For example, referring to FIG. 8, there may be at least one tab 21 on the cover/base portion that is moved into place to restrict the relative motion of the base/cover portion and the display portion. A variation on this embodiment further comprises at least one channel incorporated into the display portion, so that the tab may clear the display portion when the cover/base portion is rotated.

Because the display panel of the system will typically need some source of its own electrical power, either a conventional external or internal 120 VAC (or equivalent) power supply may be included, or a battery may be located within either or both of the base/cover portion and the display portion. As is well known in the art, both rechargeable batteries and a connection to an external power source for charging the batteries and/or powering the display may be employed. It is preferred to place any power-related components within the base/cover portion so that the weight of such components may add stability to the system when it is in the open position. It is also possible for the system to have conventional battery “bays” that accommodate removable batteries, either alone or in combination with an external power supply as is common in the art.

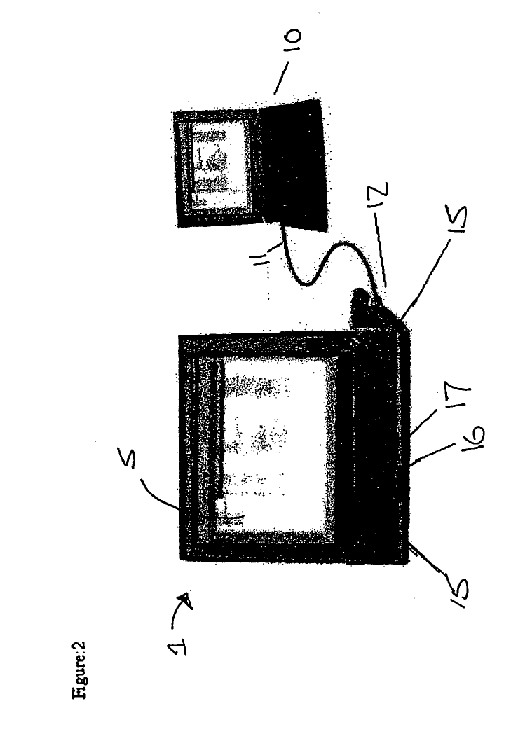

There are many possible alternative embodiments of the invention that vary from each other in the nature of the operative electronic signal connection between the graphic display panel and the display driver apparatus. As illustrated in FIG. 2, one suitable type of connection when the display driver apparatus is a common laptop computer 10, is the conventional VGA or SVGA cable 11 that may operatively connect a video output port on such a laptop computer to a video input port 12 of the invention. Another possible technology is available from Margi Systems (Fremont, Calif., USA) under the trade name DISPLAY-TO-GO when connection between a PC Card (formerly PCMCIA) slot of the laptop computer 10 and the invention is desired. As illustrated in FIG. 3, for handheld computers 13, including personal digital assistants (PDAs), a possible technology is available from the same company under the trade name PRESENTER-TO-GO in models compatible with a variety of interfaces 14 in the handheld computer, including SD Card, PC Card, Compact Flash Types I and II, and Springboard. Other types of plug-based interfaces to the display driver apparatus are within the scope of the invention.

Similarly, the format of the operative electronic signal connection between the display panel and the separate video display apparatus may be any conventional format such as those compatible with any of NTSC, PAL, SECAM, analog VGA, digital VGA, S-Video, and RGB component video.

Referring again to FIGS. 1 and 2, it is possible but not required to include at least one audio channel 15 in the inventive system, including (if appropriate but not required) appropriate connections, speakers, and controls 16 for various parameters related to the quality of the audio (volume, balance, tone, and the like). Any such controls may be manually adjustable on the system (e.g., physical knobs or switches, or an electronic control of any appropriate sort). Alternatively, because many types of separate display driver apparatus have audio sources and output connections (e.g., multimedia laptop computers), the controls for the audio channels on the inventive system may be manually adjustable on the separate display driver apparatus.

It is preferred to include controls 17 for the visual quality of the image on the display monitor in the inventive system. As with the audio channel, controls for various parameters related to the quality of the display (color balance, hue, intensity, and the like) may be manually adjustable on the system (e.g., physical knobs or switches, or an electronic control of any appropriate sort). Typically some sort of software-based application program within the electronics associated with the graphic display panel (including its driver software and hardware) may be invoked so that such parameters are adjusted directly on the portable display system, but it is possible for a software application to be resident on the separate display driver apparatus to provide suitable manual adjustment of display quality.

In another alternative embodiment, the system may further comprise at least one data transfer bus, 18, such as (but not necessarily) one meeting an established standard, e.g., RS-232C, USB, PC Card (PCMCIA), Compact Flash, Memory Stick, IEEE 1394, ISA, PCI, AGP, and the like. This enables the system to act as an auxiliary data processing device as desired.

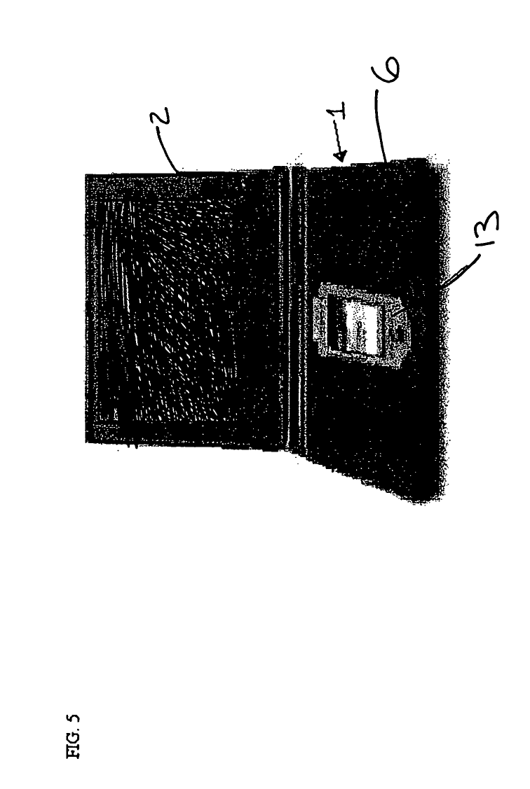

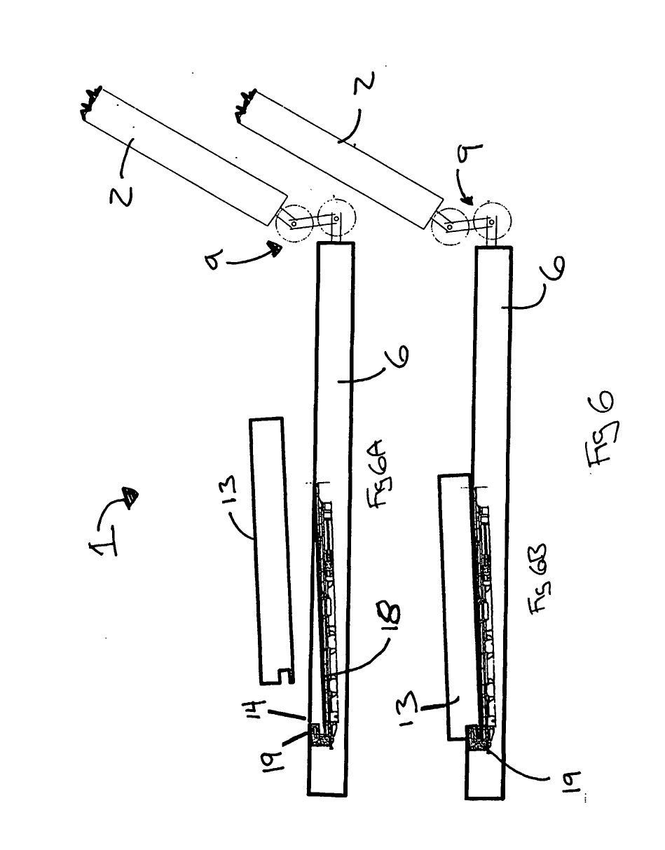

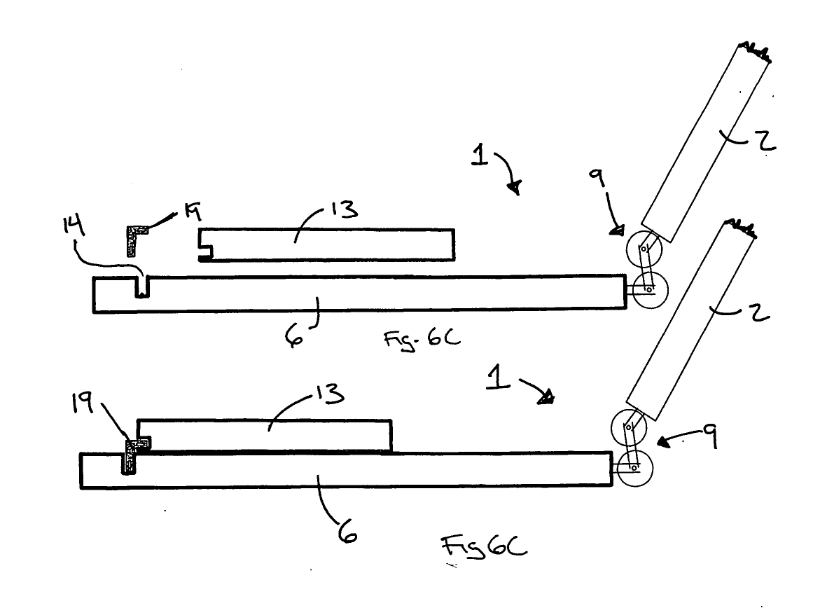

As illustrated in FIGS. 5, 6, and 7, in the particular case in which the display driver apparatus is a handheld computer 13, one embodiment of the invention further comprises a docking feature 14 for the handheld computer that is incorporated into the base/cover portion. An even more detailed embodiment further comprises a spring-loaded cover 18 to normally enclose the docking feature.

One possible connection between the handheld computer and the portable display system comprises an “L” shaped bidirectional adapter 19 having first and second ends. One end is adapted for connection to the handheld computer (or PDA), and the second end is adapted for connection to any convenient location on the system, e.g., the base/cover portion.

It will be understood that various firmware, software, and other miscellaneous electronic components may be dictated by a particular embodiment of the invention, especially the particular choice made for electronic components, connections, signal types and/or graphic display panels. For example, FIG. 7 is a schematic block diagram indicating a possible functional design in which

In general, such selections are within the scope of the art applying known principles in accordance with the definition of the invention provided by the following claims.

1. A portable display system for connection to a display driver apparatus, the system having open and closed positions, comprising:
a) a generally planar display portion having a front face and a back face, and comprising a graphic display panel arranged to be viewable on the front face;
b) a generally planar base/cover portion having a base surface and a cover surface, and having sufficient size to substantially cover the graphic display panel when the system is in the closed position, the closed position being such that the display portion is parallel to the base/cover portion;
c) a connection between the base/cover portion and the display portion that enables relative motion of the display portion to the base/cover portion between the open and closed positions, comprising a first section fixed to the base/cover portion and a second section fixed to the display portion, the first and second sections of the connection having respective axes of rotation offset from each other such that the cover/base portion may rotate behind the back face of the display portion;
d) an operative electronic signal connection between the graphic display panel and the display driver apparatus; and
e) a feature of the system to ensure that the display system may be exposed for viewing and held in the open position at an angle between the back face of the display portion and the base/cover portion that is greater than zero degrees and less than one hundred eighty degrees.

2. The system of claim 1, in which the system further comprises the display driver apparatus physically incorporated into one of the base/cover portion and display portion.

3. The system of claim 1, in which the angle is in the range of approximately seventy degrees to approximately one hundred ten degrees.

4. The system of claim 1, in which the base surface of the base/cover portion is immediately adjacent the display panel when the system is in the closed position.

5. The system of claim 1, in which the cover surface of the base/cover portion is immediately adjacent the display panel when the system is in the closed position, and the display portion undergoes a 180 degree twist to achieve the open position.

6. The system of claim 1, in which the connection between the base/cover portion and the display portion comprises a compound hinge.

7. The system of claim 1, in which the connection between the base/cover portion and the display portion connects an outer periphery of the base/cover portion and an outer periphery of the display portion.

9. The system of claim 1, in which the connection further comprises a third section joining the first section to the second section and providing the offset of the axes of rotation.

10. The system of claim 1, in which the connection between the base/cover portion and the display portion comprises at least one passage for electrical connection between the base/cover portion and the display portion.

11. The system of claim 1, in which the display panel is one of an liquid crystal display (LCD), a plasma display, an organic light emitting diode (OLED) display, and a touch screen display.

12. The system of claim 1, further comprising at least one latch to temporarily keep the base/cover portion and the display portion in the closed position.

13. The system of claim 1, in which the connection between the base/cover portion and the display portion provides sufficient friction to temporarily keep the base/cover portion and the display portion in the closed position.

14. The system of claim 1, further comprising at least one handle attached to at least one of the base/cover portion and the display portion.

15. The system of claim 1, further comprising a battery located within one of the base/cover portion and the display portion and electrically connected to provide power to the display panel.

16. The system of claim 1, further comprising a battery located within one of the base/cover portion and the display portion and electrically connected to provide power to the separate display driver apparatus.

17. The system of claim 15 or 16, in which the battery is located within the base/cover portion.

18. The system of claim 15 or 16 in which the battery is removable.

19. The system of claim 15 or 16 in which the battery is rechargeable.

20. The system of claim 1, in which the connection between the base/cover portion and the display portion comprises two linked features in a planetary gear relationship to each other.

21. The system of claim 1, further comprising a feature of the system to lock the display portion into the open position.

22. The system of claim 21, in which the feature comprises at least one tab on the cover/base portion.

23. The system of claim 22, further comprising at least one channel incorporated into the display portion so that a tab may clear the display portion when the cover/base portion is rotated.

24. The system of claim 21, further comprising recessed features in the display portion to accommodate rotation.

25. The system of claim 1, in which the operative electronic signal connection comprises a cable connection to the separate display driver apparatus.

26. The system of claim 1, in which the operative electronic signal connection comprises a plug-based interface to the separate display driver apparatus.

27. The system of claim 26, in which the integral connection comprises one of a PC Card PCMCIA) connection and a Compact Flash connection.

28. The system of claim 1, in which the operative electronic signal connection between the display panel and the separate video display apparatus is compatible with any of NTSC, PAL, SECAM, analog VGA, digital VGA, S-Video, and RGB component video.

29. The system of claim 1, further comprising at least one audio channel.

30. The system of claim 29, further comprising controls for the quality of any audio channel.

31. The system of claim 30, in which the controls are manually adjustable on the system.

32. The system of claim 30, in which the controls are manually adjustable on the separate display driver apparatus.

33. The system of claim 1, further comprising controls for the visual quality of the image on the display monitor.

34. The system of claim 33, in which the controls are manually adjustable on the system.

35. The system of claim 33, in which the controls are manually adjustable on the separate display driver apparatus.

36. The system of claim 1, further comprising at least one data transfer bus.

37. The system of claim 1, further comprising a data transfer bus meeting a standard selected from RS-232C, USB, PC Card (PCMCIA), Compact Flash, Memory Stick, IEEE 1394, ISA, PCI and AGP.

38. The system of claim 1, in which the display driver apparatus is a handheld computer.

39. The system of claim 38, in which the system further comprises a docking feature for the handheld computer that is incorporated into the base/cover portion.

40. The system of claim 39, in which the docking feature further comprises a spring-loaded cover.

41. The system of claim 38, in which the connection to the handheld computer comprises a “L” shaped bidirectional adapter having first and second ends, one end being adapted for connection to the PDA and the second end being adapted to connection to the system.

42. A method of providing an image on a portable display system having open and closed positions, comprising:
a) providing the portable display system with a generally planar display portion having a front face and a back face, and also with a graphic panel for displaying the image on the front face;
b) providing the portable display system with a generally planar base/cover portion having a base surface and a cover surface, and further having sufficient size to substantially cover the graphic display panel when the system is in the closed position, the closed position being such that the display portion is parallel to the base/cover portion;
c) providing an operative electronic signal connection between the graphic display panel and the display driver apparatus;
d) connecting an outer periphery of the base/cover portion and an outer periphery of the display portion with a first section fixed to the base/cover portion and a second section fixed to the display portion, the first and second sections of the connection having respective axes of rotation offset from each other such that the cover/base portion may rotate behind the back face of the display portion to enable relative motion of the display portion to the base/cover portion, between the open and closed positions; and
e) ensuring that the display system may be exposed for viewing and held in the open position at an angle between the back face of the display portion and the base/cover portion that is greater than zero degrees and less than one hundred eighty degrees.

43. The method of claim 42, in which connecting the base/cover portion and the display portion comprises arranging the base surface of the base/cover portion to be immediately adjacent the display panel when the method is in the closed position.
